(19) United States
(12) Patent Application Publication
(10) Pub. No.: US 2025/0135451 A1
(43) Pub. Date: May 1, 2025

(54) ELECTRODE CARTRIDGE AND DEVICE FOR THE DETECTION OF TOTAL VIABLE MICROORGANISMS (TVM), AND RELATED METHODS

(71) Applicants: YPF TECNOLOGÍA S.A., Ciudad Autónoma de Buenos Aires (AR); CONSEJO NACIONAL DE INVESTIGACIONES CIENTÍFICAS Y TÉCNICAS (CONICET), Ciudad Autónoma de Buenos Aires (AR); UNIVERSIDAD DE BUENOS AIRES, Ciudad Autónoma de Buenos Aires (AR)

(72) Inventors: Leonardo Andrés CANTONI, Ciudad Autónoma de Buenos Aires (AR); Eduardo CORTÓN, Ciudad Autónoma de Buenos Aires (AR); Federico FIGUEREDO, Ciudad Autónoma de Buenos Aires (AR); Julio Silvio FUCHS, Ciudad Autónoma de Buenos Aires (AR); María Clara PAGLIARICCI, La Plata (AR); Albert Ulises SAAVEDRA OLAYA, La Matanza (AR)

(21) Appl. No.: 18/962,846

(22) Filed: Nov. 27, 2024

Related U.S. Application Data
(60) Provisional application No. 63/595,180, filed on Nov. 1, 2023.

(51) Int. Cl. B01L 3/00; G01N 27/327

(52) U.S. Cl. CPC B01L 3/50; G01N 27/3277; B01L 2200/026; B01L 2200/0689; B01L 2300/0645; B01L 2300/0681

(57) ABSTRACT

The present invention relates to an electrode cartridge, a device that comprises said electrode cartridge for the detection of total viable microorganisms (TVM) in a sample, and a method for determining the total viable microorganisms present in a sample that comprises the use of said device.

### CROSS REFERENCE TO RELATED APPLICATIONS

This application claims priority of U.S. Provisional Application No. 63/595,180 filed on Nov. 1, 2023 under 35 U.S.C. § 119(e), the entire contents of which are hereby incorporated by reference.

### TECHNICAL FIELD OF THE INVENTION

The present invention relates to an electrode cartridge, a device for the semiautomatic determination of the amount and concentration of total viable microorganisms (TVM) in a sample that comprises said electrode cartridge, and a method for determining the amount and concentration of TVM in a sample by using the device of the present invention.

### BACKGROUND

Determining the amount and/or concentration of total viable microorganisms (TVM) is of great importance in a number of industries and processes. One of the industries where this parameter is of mayor relevance is the oil and gas industry, where significant amounts of water are used and injected into wells as part of different processes. If the concentration of viable microorganisms in the process water is high, damage to the metal structures (MIC) and alteration of the product, e.g. acidification, can occur. Therefore, the water must be treated to avoid an increase in the amount of total microorganisms. With this objective in mind, there are different methods to know the state of the water, as well as to determine the effectiveness of biocidal treatments. The methods used for the quantification of TVMs include the growth of microorganisms on a plate or liquid medium, direct observation by microscopy, the use of flow cytometry, and the use of quantitative PCR, among others.

Nevertheless, these methods are slow or require a complex analytical laboratory, thus new methods based on ATP measurement are being developed in the field. Since this molecule is present in all living beings, and its concentration is proportional to the microbial biomass, the amount of ATP can be used as a parameter to determine the TVM in a sample. However, this method is generally not semiautomated and requires expert operators, since it is based on enzymatic reactions that produce light in the presence of ATP. The amount of ATP is then determined as a function of intensity (luminescence) and from there the TVMs are quantified.

In view of these difficulties and limitations in the prior art, the present invention presents an electrode cartridge, a device and a method for the quantification of TVM based on the estimation of microbial redox metabolism.

These types of reactions, as well as ATP, are present in all living beings. However, the method of the present invention has the following advantages over the estimation of TVM based on ATP: a) it requires fewer operations by the operator because it is semiautomatic b) all calculations and actions are performed automatically by the device of the present invention, so that the operation error is lower; c) the sampling cost is lower.

Electrochemical methodologies based on redox reactions for the determination of the presence of microorganisms are known in the prior art. The following citations correspond to documents that describe methods and/or devices similar to the invention, highlighting their limitations.

### Non-Patent Documents

Ramsay et al. (Rapid bioelectrochemical methods for the detection of living organisms; 1985) disclose a methodology for determining the number of microorganisms by utilizing an amperometric cell of 2 and 3 metallic electrodes. They detect concentrations of E. coli between 6×10⁶ to 6×10⁸ CFU/mL in around 15 minutes. However, the disclosed method is not automatic, doesn't work in flow and the sample has to be incubated in a water bath. Furthermore, the determination is based on the biological demand of oxygen.
Patchett et al. (Rapid detection of bacteria by an amperometric electrode system—a comparison of some redox mediators; 1989) disclose the use of amperometric cells to determine the presence of redox mediators, such as ferricyanide, to determine the amount of E. coli in water samples. However, the disclosed invention is neither automatic nor semiautomatic. Additionally, the device lacks an incubation compartment and can't perform the needed reactions in flow.
Ding and Schmid (Rapid determination of microorganisms using a flow-injection system; 1990) disclose a flow system designed to determine the number of cells present in a fermentation reactor. The detector is a 3-electrode amperometric cell of the “wall jet” type. The flow system takes a sample from the reactor to which ferricyanide is added, then the flow is stopped for 4 minutes to allow the cells to reduce the redox mediator and then injected into the detection cell. The linear range of detection is 4.7×10⁶ to 2.4×10⁹ colony forming cells (E. coli) per milliliter. However, the disclosed invention was developed for the monitoring of bioprocesses comprising microbiological fermentation, thus it doesn't solve the technical problem of quantifying the total viable microorganisms (TVM) present in a liquid sample.
Yong et al. (Detecting total toxicity in water using a mediated biosensor system with flow injection; 2015) disclose the use of a detection system based on the physical immobilization of bacteria on fibers inside a bioreactor. Said immobilized cells are incubated for a certain amount of time, afterwards the sample is injected into the 3-electrode cell. The determination is carried out under flow conditions using amperometric techniques. Organic matter present in the sample is consumed by the microorganisms immobilized on the electrode, while the bacteria reduce a redox mediator, which is oxidized on the electrode surface. However, the document doesn't disclose nor teach how to quantify the TVM in an unknown sample and utilizes as the parameter the biological oxygen demand (BOD).

### PATENT DOCUMENTS

The published patent U.S. Pat. No. 5,348,862 A1 discloses a method for amperometrically measuring the bacterial content of liquids in a bioelectrochemical cell comprising a redox mediator. Placing the mediator in contact with the bacteria in the sample results in an initial response at the electrode. The capture system is then contacted again after the death of the bacteria present, producing a second response due to interfering substances (base signal), which is subtracted from the first response. An apparatus for implementing this method is also provided. However, the disclosed method is not automatic nor semiautomatic. Furthermore, using a two-electrode system has trouble maintaining a stable reference potential, and it is particularly sensible to contamination present in a sample.
The published patent U.S. Ser. No. 10/179,927 B2 discloses a method consisting of (a) contacting the sample with an electrochemically active reporter, which is a conjugate comprising both the redox reporter and a covalently bonded sugar moiety such that the covalent bond can be enzymatically cleaved in the presence of the microorganism by an enzyme expressed by the microorganism. The reporter is of the resorufin group and compounds with aryl or heteroaryl group rings, under conditions that allow enzymatic cleavage of the covalent bond between the sugar moiety and the redox moiety in the presence of the microorganism; (b) determine electrochemically the redox moiety released; and (c) determine the presence of the microorganism and, optionally, the number of microorganisms in the sample based on the redox moiety released. However, the disclosed method uses specific reagents for a group or type of microorganism, since it is based on the enzymatic rupture of a bond between the electrochemical molecule (which is the one that will be detected on the electrode) and a sugar. These enzymes are specific to a group of bacteria, so this procedure presents limitations to the type of organisms it can detect.

In view of the limitations present in the devices and methods of the prior art, there's a need to provide a semiautomatic device and method that allows to determine the total viable microorganisms (TVM) present in an unknown liquid sample by analyzing the redox metabolism of the microorganisms present in said unknown liquid sample. Additionally, there's also a need for determining the TVM present in an unknown liquid sample in a flow system and with relatively high speed, for example, in a few minutes.

### BRIEF DESCRIPTION OF THE INVENTION

In light of the limitations of the state of the art mentioned above, the present invention provides an electrode cartridge, a device that semiautomatically determines the total viable microorganisms (TVM) present in an unknown liquid sample by analyzing the redox metabolism of the microorganisms present in said unknown liquid sample, and a method for semiautomatically determining the total viable microorganisms (TVM) present in an unknown liquid sample by analyzing the redox metabolism of the microorganisms present in said unknown liquid sample.

Additionally, said device determines the TVM present in an unknown liquid sample in a flow system and with relatively high speed, for example, in a few minutes.

Consequently, a first aspect of the present invention is an electrode cartridge that comprises two subunits, wherein
a first subunit comprises a main compartment with three openings, wherein the first and second opening are located in opposite ends of the compartment on a longitudinal axis, and the third opening is located perpendicular to the other two openings, a working electrode (WE), and a counter electrode (CE), wherein said working electrode and counter electrode are located within said main compartment; and
a second subunit comprises a detachable adapter that can be attached to and detached from the main compartment from the third opening, and a reference electrode (RE) located within said detachable adapter.

The main compartment openings comprise leak-proof connectors. In an embodiment, the leak-proof connectors are selected from Luer connectors, barb connectors, thread connectors, more preferably the leak-proof connectors are Luer connectors.

In an embodiment, the leak-proof connectors are made of a material selected from Teflon, PEEK, polypropylene, nylon, FKM, FFKM, FEP, Delrin, PMMA, PPS, silicone, polycarbonate, brass, titanium, or TPE.

Preferably, the leak-proof connectors are selected from
¼″-28 a 1/16″ Flangeless made of Ethylene tetrafluoroethylene,
¼″-28 Swivel to Barbed 3/32″ ID made of Teflon, PEEK or polypropylene,
Male Luer Lock to Female ¼″-28 made of Teflon, PEEK or polypropylene,
Female Luer to female ¼″-28 made of Teflon, PEEK or polypropylene,
Barbed male to ¼″-28 adapter for 1/16″ or 1/18″ OD made of Teflon, PEEK or polypropylene,
¼″-28 Super Flangeless Nut for 1/16″ or 1/32″ OD made of Teflon, PEEK or polypropylene,
Male Luer to female ¼″-28 adapter made of Teflon, PEEK or polypropylene,
Female Luer to ¼″-28 male made of Teflon OR PEEK,
6/40 to 1/14″-28 adapter made of Teflon, PEEK or polypropylene,
¼″-28 to ⅛″ OD made of Teflon, PEEK or polypropylene,
All one piece or with ferrule made with Ethylene tetrafluoroethylene
¼″-28 female to 10-32 male flat bottom adapter made of Teflon, PEEK or polypropylene,
Male Luer to Male ¼″-28 made of Teflon, PEEK or polypropylene,
Microbarb peristaltic tubing to ¼″-28 Adapter made of Teflon, PEEK or polypropylene,
1/14″-28 male union adapter made of Teflon, PEEK or polypropylene,
Female Luer to male 10-32 coned adapter made of Teflon, PEEK or polypropylene,
¼″-28 super flangeless nut for ⅛″ OD made of Teflon, PEEK or polypropylene,
10-33 female to ¼″-28 male adapter made of Teflon, PEEK or polypropylene,
¼″-28 female to ¼″-28 male flat bottom adapter made of Teflon, PEEK or polypropylene,
Microtight for 1/16″ OD to 1/32″ OD adapter made of Teflon, PEEK or polypropylene,
6-40 flat bottom nut made of Teflon, PEEK or polypropylene,
One piece fingertight 10-32 coned fitting for 1/16″ OD made of Teflon, PEEK or polypropylene,
10-32 coned union adapter made of Teflon, PEEK or polypropylene,
Female 10-32 male Luer lock adapter made of Teflon, PEEK or polypropylene,
10-32 coned plug made of Teflon, PEEK or polypropylene,
Female Luer to female 10-32 coned adapter made of Teflon, PEEK or polypropylene,
Female Luer to Male 10-32 coned adapters made of Teflon, PEEK or polypropylene,
¼″-28 female flat bottom to 10-32 coned male adapter made of Teflon, PEEK or polypropylene,
10-32 UNF to female Luer adapter made of Teflon, PEEK or polypropylene,
Fingertight double-wing 10-32 coned fitting for 1/16″ OD made of Teflon, PEEK or polypropylene,
Barbed to male Luer adapter for soft walled tubing made of Teflon, PEEK or polypropylene,
Barbed to male Luer Slip adapter made of Teflon, PEEK or polypropylene,
Male Luer lock to barb adapter made of Teflon, PEEK or polypropylene,
Barbed to male ¼-28 adapter for 0.02″ to 1/32″ ID soft walled tubing made of Teflon, PEEK or polypropylene,
Masterflex male Luer slip to barb adapter made of Teflon, PEEK or polypropylene,
Masterflex T barb connector made of Teflon, PEEK or polypropylene,
Stand-alone female olive ports made of Teflon, PEEK or polypropylene,
Masterflex straight barb connector made of Teflon, PEEK or polypropylene,
Male Luer to lock barb adapter made of Teflon, PEEK or polypropylene,
Masterflex reducer barb connector made of Teflon, PEEK or polypropylene,
Male Luer to Barb adapter made of Teflon, PEEK or polypropylene,

Further descriptions of the leak-proof connectors comprised by the electrode cartridge of the present invention can be found in the Examples herein.

In an embodiment, the electrode cartridge of the present invention may be utilized in a fluidic system, wherein a liquid sample flows through said electrode cartridge.

The working electrode comprises a wire as current collector. In an embodiment, said wire is made of a material or combination of materials selected from titanium, stainless steel, or carbon, more preferably titanium.

In another embodiment, the working electrode comprises a cladding wire as a current collector, where said cladding wire is covered by a material or combination of materials selected from titanium, stainless steel, or carbon, more preferably titanium.

The counter electrode comprises a wire as current collector. In an embodiment, said wire is made of a material or combination of materials selected from titanium, stainless steel, or carbon, more preferably titanium.

In another embodiment, the counter electrode comprises a cladding wire as a current collector, where said cladding wire is covered by a material or combination of materials selected from titanium, stainless steel, or carbon, more preferably titanium.

The reference electrode comprises a wire as a current collector. In an embodiment, said wire is made of silver and silver chloride, or saturated calomel, or copper and copper (II) sulfate, or mercury and mercurous sulfate. For example, the reference electrode may be selected from
Silver chloride electrode (E=+0.210 V in 3.0 mol KCl/L)
Silver chloride electrode (E=+0.22249 V in 3.0 mol KCl/L)
Saturated calomel electrode (SCE) (E=+0.241 V saturated KCl/L)
Copper-copper(II) sulfate electrode (CSE) (E=+0.314 V)
Mercury-mercurous sulfate electrode (E=+0.64 V in saturated K₂SO₄, E=+0.68 V in 0.5 M H₂SO₄) (MSE)

In an embodiment, the working electrode, the counter electrode, or both, comprise at least one disc made of a porous carbon material or combination of materials. In an embodiment, the working electrode comprises 1, 2, 3, 4, 5 or more discs, more preferably the WE comprises 3 discs. In an embodiment, the counter electrode comprises 1, 2, 3, 4, 5 or more discs, more preferably the CE comprises 3 discs.

The exact number of discs contained within the working and/or counter electrode depends on how thick the material is, as a person skilled in the art can appreciate, a thicker material would result in lesser number of discs, while a lighter material would result in a greater number of disks.

As it can be appreciated, the porous material provides the electrode of a higher area for contacting the solution to be measured, thus providing a more efficient way of producing the electro-chemical reaction and analytical measurement.

In an embodiment, the at least one disc of the WE has a width of 4 mm, and a diameter of 10 mm. In an embodiment, the at least one disc of the CE has a width of 12 mm, and a diameter of 10 mm.

In an embodiment the at least one disc is made of a material or combination of materials that comprises carbon. Preferably, selected from the list consisting of carbon cloth, carbon fabric, carbon paper, carbon wool, carbon fiber, carbon felt, and graphite felt, more preferably carbon felts or graphite felts.

In another embodiment, the at least one disc further comprises artificial foam-like materials based on nickel, titanium, carbon, graphite, glassy carbon, carbon nanotubes, or graphene; or covered with a layer of nickel, titanium, carbon, graphite, glassy carbon, carbon nanotubes, or graphene, wherein said layer can be in the scale of nanometers, micrometers or millimeters. In an embodiment, the layer may be in the form of a continuous layer or in the form of nanoparticle or microparticle coating.

In an embodiment, the porous material or combination of materials has a pore radius between 0.2 μm y 2 mm, preferably 10 μm.

In a particularly preferred embodiment, the working electrode, and the counter electrode each comprise a titanium wire as current collectors, and carbon felt disks as working and counter electrode, and the reference electrode comprises a silver wire covered with silver chloride, the silver wire is used also as current collector.

A second aspect of the present invention is a device for the semiautomatic determination of the total viable microorganisms present in a liquid sample that comprises:
a fluidic system, wherein said fluidic system comprises
   a sample solution container,
   a measuring solution container,
   at least one peristaltic pump connected to the sample solution container and the measuring solution container,
   a pressure sensor downstream the at least one peristaltic pump,
   a filtering cartridge downstream the pressure sensor,
   an electrode cartridge according to the first aspect of the present invention downstream the filtering cartridge,
   a flow sensor downstream the electrode cartridge,
   a residue compartment downstream the flow sensor;
a thermostatic chamber, wherein said thermostatic chamber contains within
   a cartridge elevator system,
   the filtering cartridge of the fluidic system fixed placed over the cartridge elevator system,
   the electrode cartridge of the fluidic system fixed over the cartridge elevator system;
an electronic control module;
a data processing module;
an electrochemical control module, wherein said electrochemical control module comprises a potentiostat

In an embodiment, the fluidic system may comprise at least one solenoid valve. In another embodiment, the fluidic system comprises 0, 1, 2, 3, 4, 5, 6, 7, 8, 9, or 10 solenoid valves. Preferably, the fluidic system comprises
a solenoid valve that regulates the flow of liquid flowing out of the solution sample container,
a solenoid valve that regulates the flow of liquid flowing out of the measuring solution container,
a solenoid valve that regulates the flow of liquid flowing into the thermostatic chamber, and
a solenoid valve that regulates the flow of liquid flowing out of the thermostatic chamber.

The device of the present embodiment is contained within a suitcase. In a preferred embodiment, said suitcase measures between 40-100 cm long, 30-75 cm wide, and 15-60 cm high.

In an embodiment, the suitcase measures 79.5 cm long, 51.8 cm wide and 31 cm high.

In another embodiment, the suitcase measures 43 cm long, 33 cm wide and 18 cm high.

A third aspect of the present invention is a method for determining the total viable microorganisms (TVM) present in a liquid sample, comprising the steps of
a) obtaining a liquid sample containing microorganisms in suspension,
b) filtering the microorganisms present in the sample of step a),
c) cultivating the microorganisms obtained in step b) in a solution comprising redox mediators,
d) carrying out a reduction of the mediators with the microorganisms obtained in step b),
e) introducing the product of the reaction of step d) in an electrode cartridge of the first aspect of the invention,
f) oxidizing the product of the reaction of step d) in the electrode cartridge of the first aspect of the invention,
g) producing an amperometric signal via the oxidation reaction of step f),
h) calculating the TVM present in the liquid sample of step a) from the amperometric signal of step g).

In an embodiment, the microorganisms in suspension of step a) comprise microorganisms that can cause damage to metal structures and alteration of an oil or gas product. In a preferred embodiment, said microorganisms are capable of producing microbially induced corrosion (MIC). Said microorganisms comprise bacteria, archaea, or fungi acid. Preferably, acid producing bacteria; iron related bacteria, iron-oxidizing or iron-reducing bacteria, for example, bacteria from the genera Gallionella, Crenothrix, Sphaerotilus, Siderocapsa, Thiobacillus or Pseudomonas; slime forming bacteria; sulfate reducing bacteria, for example bacteria from the genera Desulfovibrio, Desulfomonas, or Desulfotomaculum.

Further descriptions of the microorganisms detectable by the device of the present invention can be found in the Examples herein. The disclosed microorganisms are to be understood only as an exemplary list of microorganisms and not as an exhaustive list.

In an embodiment, the solution of step c) comprises at least one redox mediator selected from the list consisting of ferricyanide, neutral red, safranine, phenazine ethosulfate, methylene blue, new methylene blue, toluidine blue O, Thionine, phenothiazinone, resorufin, gallocyanine, 2-hydroxy-1,4-naphthoquinone, anthraquinone-2,6-disulfonate, sulfur- or iron-based compounds, fulvic or humic acids, aromatic amine; ammonium sulfate or sulfite, azo dyes sulfate or sulfite, more preferably ferricyanide.

As a person of skill in the art will appreciate, when referring to redox mediators which correspond to ions, such as ferricyanide, it is to be understood that the solution comprising such mediators actually comprises salts thereof. For instance, if the redox mediator is ferricyanide, the solution comprises a ferricyanide salt, typically potassium ferricyanide.

As a person skilled in the art would appreciate, the product of the reaction of step d) comprises the reduced form of the redox mediator selected from the list of redox mediators described above. For example, and without intent to limit the scope of the present invention, when using ferricyanide as a redox mediator, the product of reaction comprises ferrocyanide.

The method of the present invention is capable of detecting the total viable microorganisms in a concentration of 10³-10¹⁴ CFU/ml, preferably between 10⁵-10¹⁰ CFU/ml.

### BRIEF DESCRIPTION OF THE FIGURES

FIG. 1 shows a detailed view of a preferred embodiment of the electrode cartridge of the present invention from different angles.

FIG. 1, A shows a schematic of the interior of the electrode cartridge.

FIG. 1, B shows an external, frontal view of the electrode cartridge. The line indicated as A in FIG. 1, B points to the cutting plane from which FIG. 1, A is obtained.

FIG. 1, C shows an external, lateral view of the electrode cartridge.

FIG. 2 shows a detailed view of another preferred embodiment of the electrode cartridge, wherein the reference electrode (RE) is immersed in a compartment containing KCl in high concentration.

FIG. 2, A shows a schematic of the interior of the electrode cartridge.

FIG. 2, B shows an external, frontal view of the electrode cartridge. The line indicated as A in FIG. 2, B points to the cutting plane from which FIG. 2, A is obtained.

FIG. 2, C shows an external, lateral view of the electrode cartridge.

FIG. 3 shows a schematic representation of a preferred embodiment of the device of the present invention, in a three-pump configuration.

FIG. 4 shows a general view of a preferred embodiment of the device of the present invention.

FIG. 5 shows a view of a preferred embodiment of the peristaltic pumps and their structural support of said peristaltic pumps.

FIG. 6 shows a detailed view of a preferred embodiment of the cartridge elevator system.

FIG. 7 shows graphs of responses of current vs time of different samples.

FIG. 7, A shows signals typically obtained during measurement of a blank or a sample without microorganisms

FIG. 7, B shows signals typically obtained during measurement of a calibration pattern of ferrocyanide.

FIG. 7, C shows signals typically obtained during measurement of a sample with a relatively high content of microorganisms.

FIG. 7, D shows signals typically obtained during measurement of a sample with a relatively low content of microorganisms.

FIG. 8 shows a schematic representation of a preferred embodiment of the device of the present invention, in a single pump configuration.

FIG. 9 shows comparative results obtained for representative samples of a field assay carried out in an oil field, using: (i) the device of the invention in peak intensity-measuring mode (dark grey bar); the device of the invention in charge-measuring mode (light grey bar); and an ATP-based commercial device (black bar).

### DETAILED DESCRIPTION OF THE INVENTION

Each and all embodiments of the aspects of the present invention resulting from the combination of particular embodiments described in the present application are to be considered as falling within the scope of the present invention.

Any technical terminology used herein shall be understood by the common definition utilized in the art and/or by those skilled in the art, unless otherwise explicitly stated or inferred by context.

As the person skilled in the art would infer by the descriptions herein, the fluidic system of the present invention is designed to work with liquids and not with gases. Therefore, the term fluidic when referring to the system may be used indistinguishable from the term “hydric” or “hydraulic”.

In each of the Figures the same numeric references are used to designate similar or equal elements of the objects of the present invention.

### Electrode Cartridge

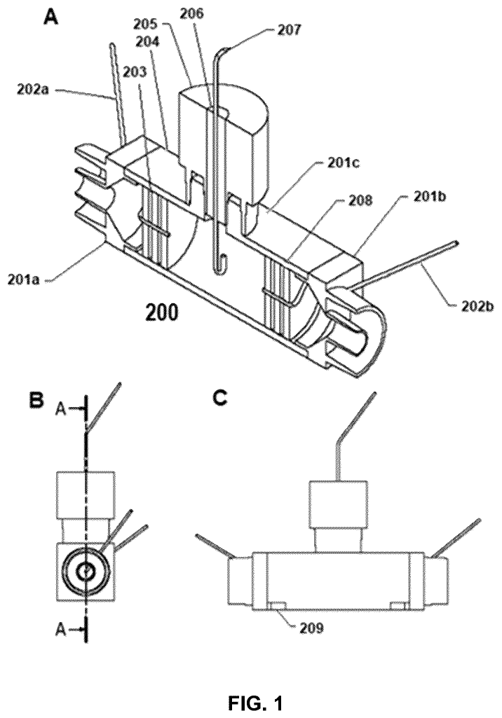

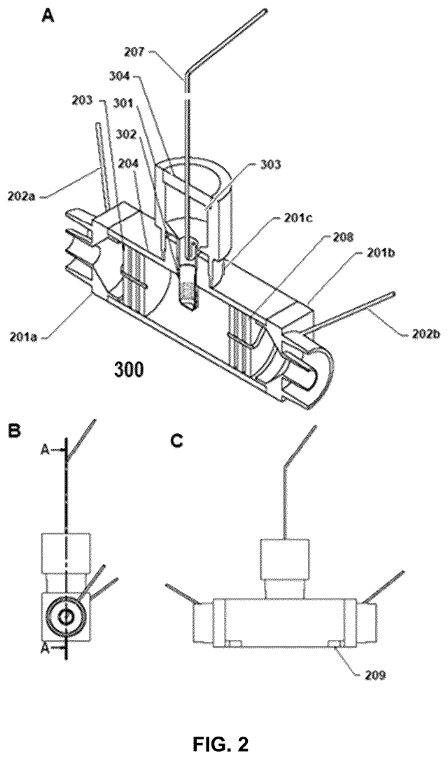

The following is a detailed description of preferred embodiments of an electrode cartridge of the present invention as shown in FIGS. 1 and 2. These are exemplary embodiments, and they are not intended to limit the scope of the present invention in any way.

The inventors of the electrode cartridge of the present invention developed said electrode cartridge with the following characteristics, which represent a clear advantage over similar cartridges present in the prior art:
1) the fabrication uses non-noble nor high-cost metals or contaminants (gold, platinum, palladium, etc.), and neither incorporates nanoparticle materials or other materials that can be considered hazardous. Thus, the electrode cartridge can be discarded as a common residue;
2) the manufacture of the electrode cartridge is simple and serigraphy equipment or clean chambers are not required, thus it can be performed in relatively simple electronic workshop;
3) the electrode cartridge is made of carbon or graphite cloth, fabric, paper, wool or fiber, which provides a higher electroactive area, of between 0.5-25 m² in an electrode comprising 3 discs, thus increasing the sensitivity of the technique when compared with other electrodes present in the state of the art (this feature is present in both the working and counter electrode);
4) the reference electrode is a salt-bridge electrode, which allows to fix the working potential in a precise manner, unlike other disposable electrode cells that use a reference pseudo-electrode, which does not allow a precise control of the applied potentials to said electrode cell;
5) given its construction that does not use nanoparticles, thin or thick layer electrodes made by lithography, or other types of electrodes constructed by methods that require clean rooms, or the precise deposition of materials on substrates, the present electrode cartridge is very robust and can be used to measure tens or hundreds of samples;
6) in contrast to prior art devices based on ATP detection, the device of the present invention is semiautomatic, does not require refrigeration of sensitive reagents, does not require either the measurement of liquids or dissolving solids, and produces an amount of disposable plastic material lower than 10% of the one produced by ATP-based devices.

Thanks to the design of the electrode cartridge of the present invention, it is capable of performing the needed reactions in flow, it is capable of maintaining a stable reference potential, and is robust to the presence of contamination present in a sample, it is capable of detecting the presence of a redox mediator and therefore can be used to determine the total viable microorganisms, independently of the type of microorganism present in the sample, it is suitable for use in a device that can semiautomatically determine the presence of TVM in a liquid sample. These advantages represent an improvement when compared to other electrodes present in the state of the art. The electrode cartridge of the present invention, as a whole, works as a disposable element, that can be used between 10-100 analysis, depending on the type of sample analyzed. The precise duration of the electrode cartridge would depend on how aggressive the sample is to the electrodes or if this causes an irreversible contamination of the electrode cartridge that reduces its useful lifetime.

The following descriptions correspond to an electrode cartridge 200 as shown in FIG. 1 or an electrode cartridge 300 as shown in FIG. 2. These electrodes are exemplary embodiments of the electrode cartridge of the present invention and do not intend to limit the scope thereof.

The electrode cartridge 200 comprises the following components:

| 201a. | Luer connector (entrance) | 201b. | Luer connector (exit) |
|---|---|---|---|
| 201c. | Luer connector (adapter) | 202a. | Metal wire 1 |
| 202b. | Metal wire 2 | 203. | Working electrode (WE) |
| 204. | Electrode cartridge | 205. | Reference electrode (RE) |
| | compartment | | adapter |
| 206. | Hydraulic seal | 207. | Reference electrode (RE) |
| 208. | Counter electrode (CE) | 209. | Fixing element |

The electrode cartridge 200 can be described as two different subunits, wherein the first subunit is a compartment with three openings, and the second subunit is a detachable adapter.

The compartment with three openings comprises the following components:
an electrode cartridge compartment 204, that works as the main compartment,
Luer connectors 201a, 201b, and 201c, each of them comprising an opening of 3 mm,
a working electrode 203, comprising 3 discs of a porous material and a metal wire 202a as a current collector, wherein the metal wire is made of titanium, and the porous material is carbon felt or graphite felt,
a counter electrode 208, comprising 4 discs of a porous material and a metal wire 202b as a current collector, wherein the metal wire is made of titanium, and the porous material is carbon felt or graphite felt,
a fixing element 209, comprising a magnet.

The detachable adapter of the electrode cartridge 200 comprises:
a reference electrode adapter 205, comprising a Luer adapter that's complementary to the Luer connector 201a,
a reference electrode 207, comprising a metal wire as a current collector, wherein said wire is made of silver,
a hydraulic seal 206, wherein said hydraulic seal is made of rubber, silicone or other flexible polymers,

The way the components of the compartment with three openings of the electrode cartridge 200 interrelate with each other is described as follows:

The Luer connector 201a works as the entrance to the electrode cartridge compartment 204, while the Luer connector 201b works as the exit of the cartridge compartment 204. Both connectors 201a and 201b are located over the same longitudinal axis. The compartment 204, also comprises a third Luer connector 201c located in a perpendicular axis to both connectors 201a and 201b. The working electrode (WE) 203 is located near the Luer connector 201a, and it is placed inside the compartment 204 in a way that forces the flow of the fluid through the pores of its porous material. The metal wire 202a is placed in direct contact with said porous material of the WE 203. The counter electrode (CE) 208 is located near the Luer connector 201b and it is placed inside the compartment 204 in a way that forces the flow of the fluid through the pores of its porous material. The metal wire 202b is placed in direct contact with said porous material of the CE 208. The compartment with three openings of the electrode cartridge 200 is then fixed to an Electrode cartridge fixing system with a fixing element 209.

The way the components of the detachable adapter of the electrode cartridge 200 interrelates with each other, and with the compartment with three openings of the electrode cartridge 200 is described as follows:

The container 204 is attached through the Luer connector 201c to a reference electrode adapter 205. The reference electrode adapter 205 has a reference electrode (RE) 207 that's held in place by means of a hydraulic seal 206. This adapter 205, and correspondingly the RE 207 are placed perpendicular to the Luer connector 201a and the Luer connector 201b, in such a way that the RE 207 is located inside the compartment 204, between the WE 203 and the CE 208.

The electrode cartridge 300 comprises the following components:

| 201a. | Luer connector (entrance) | 201b. | Luer connector (exit) |
|---|---|---|---|
| 201c. | Luer connector (adapter) | 202a. | Titanium wire 1 |
| 202b. | Titanium wire 2 | 203. | Working electrode (WE) |
| 204. | Electrode cartridge compartment | 207. | Reference electrode (RE) |
| 208. | Counter electrode (CE) | 209. | Fixing element (magnet) |
| 301. | Reference electrode adapter | 302. | Porous connector |
| 303. | Reference electrode compartment | 304. | Hydraulic seal |

The electrode cartridge 300 can be described as two different subunits, wherein the first subunit is a compartment with three openings, and the second subunit is a detachable adapter.

The compartment with three openings of the electrode cartridge 300 comprises the same components as those of the compartment with three openings of the electrode cartridge 200. The way the components of the compartment with three openings of the electrode cartridge 300 interrelate with each other is the same as the way the components of the compartment with three openings of the electrode cartridge 200 interrelate with each other.

The way the components of the detachable adapter of the electrode cartridge 300 interrelate with each other, and with the compartment with three openings of the electrode cartridge 300 is described as follows:

The container 204 is attached through the Luer connector 201c to a reference electrode adapter 302 comprising a porous connector 301, a reference electrode compartment 304, a hydraulic seal 303, and a reference electrode 207.

The container 204 is attached through the Luer connector 201c to a reference electrode adapter of the cartridge 300. The reference electrode adapter 205 has a reference electrode (RE) 207 that is held in place by the means of a hydraulic seal 206.

The container 204 is attached through the Luer connector 201c to a reference electrode adapter 301. The reference electrode adapter 301 has a reference electrode (RE) 207 that is held in place by means of a hydraulic seal 303. This adapter 301, and correspondingly the porous connector 302 are placed perpendicular to the Luer connector 201a and the Luer connector 201b, in such a way that the porous connector 302 is located inside the compartment 204, between the WE 203 and the CE 208. The reference electrode 207, is placed inside the reference electrode compartment 304, submerged in a high concentration salt solution.

In this particular embodiment, the reference electrode 207, that is inside the compartment 304, has a higher precision, thus allowing a precise control of the potentials applied to the working electrode 203.

In an embodiment, the working electrode 203 and the counter electrode 208 comprises are at least 1 disc having a diameter of 1-20 mm, preferably 10-12 mm.

In an embodiment, the working electrode 203 and the counter electrode 208 comprises a porous material having an average pore radius of 0.2 m-2 mm, preferably 10 μm.

In an embodiment, the reference electrode 207 is submerged in a high concentration salt solution comprising a KCl salt, preferably wherein the KCl salt is between 1 M and saturation, preferably 4 M.

In an embodiment, the Electrode Cartridge compartment 204 is manufactured by a 3D printer or by injection of a proper material in a matrix designed with the proper shape. Preferably, said compartment 204 is made of a plastic, optionally, transparent plastic.

In an embodiment, the Electrode Cartridge compartment 204 can be manufactured by making two halves and sealing these together afterwards, for example, by using a microwave, a glue, or any other proper technique.

### Device

The electrode cartridge of the present invention is designed to be used attached to a device that is capable of semiautomatically analyzing a liquid sample to determine the amount of TVM present therein. It is thus an additional aspect of the present invention to provide a device for the semiautomatic determination of the total viable microorganisms present in a liquid sample that comprises an electrode cartridge according to the first aspect of the invention, which may exhibit different configurations.

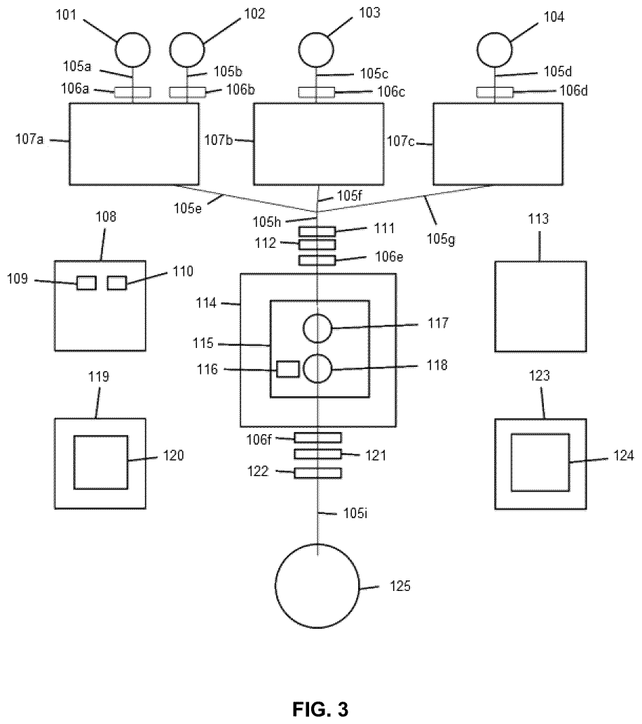

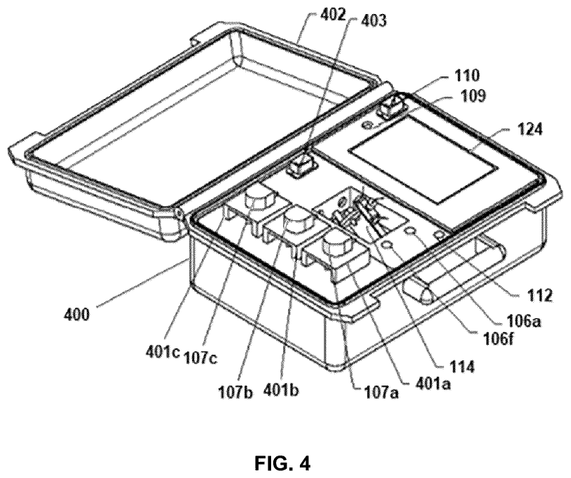

The following is a detailed description of a preferred embodiment of said device as shown in FIGS. 3 and 4. These are exemplary embodiments, and are not intended to limit the scope of the present invention in any way.

The device of the FIG. 3 comprises the following elements:

| 100. | Device of the present invention | | |
|---|---|---|---|
| 101. | Sample solution | 102. | Cleaning solution |
| 103. | Calibrating solution | 104. | Carrier or measuring |
| | | | solution |
| 105a. | Tubing 1 | 105b. | Tubing 2 |
| 105c. | Tubing 3 | 105d. | Tubing 4 |
| 105e. | Tubing 5 | 105f. | Tubing 6 |
| 105g. | Tubing 7 | 105h. | Tubing 8 |
| 105i. | Tubing 9 | 106a. | Solenoid valve 1 |
| 106b. | Solenoid valve 2 | 106c. | Solenoid valve 3 |
| 106d. | Solenoid valve 4 | 106e. | Solenoid valve 5 |
| 106f. | Solenoid valve 6 | 107a. | Peristaltic pump 1 |
| 107b. | Peristaltic pump 2 | 107c. | Peristaltic pump 3 |
| 108. | Power supply module | 109. | On/Off switch |
| 110. | Power supply plug | 111. | Bubble trap |
| 112. | Pressure sensor | 113. | Electronic control module |
| 114. | Thermostatic chamber | 115. | Cartridge elevator system |
| 116. | Vibrating bubble eliminator | 117. | Filtering cartridge |
| 118. | Electrode cartridge | 119. | Electric noise insulator |
| 120. | Electrochemical control module | 121. | Dumpener |
| 122. | Flow sensor | 123. | Data-processing module |
| 124. | Display touch | 125. | Residue container |

The following is an exemplary description of how the device represented in FIG. 3 works. This description is merely an exemplary embodiment of the present invention and does not intend to limit the scope thereof.

A sample solution 101 preferably comprising microorganisms in any of the embodiments of the present invention is introduced in the device 100. Said sample solution 101 is connected by a tubing 105a to a pump 107a. The flow of said sample solution 101 can be regulated via the activation of the pump 107a and by opening a solenoid valve 106a.

A measuring solution 104 comprising a redox mediator in any of the embodiments of the present invention is introduced in the device 100, separated from the sample solution 101. Said measuring solution 104 is connected by a tubing 105d to a pump 107c. The flow of said measuring solution 104 can be regulated via the activation of the pump 107c and by opening a solenoid valve 106a.

By activating the pump 107a and opening the solenoid valve 106a, the sample solution 101 is transported through the tubing 105a and 105e, to the tubing 105h. The sample solution 101 goes through a bubble trap 111 that eliminates bubbles, and a pressure sensor 112 that senses the pressure of the liquids flowing through the tubing 105h. The device can regulate the entrance of fluids to a thermostatic chamber 114 by controlling the flow through a solenoid valve 106e.

The solution 101 enters a thermostatic chamber 114 and, located on top of a cartridge elevator system 115, there is a bubble eliminator 116, a filtering cartridge 117, and an electrode cartridge of the present invention 118. After opening the solenoid valve 106e, the solution 101 flows through a filtering cartridge 117, where microorganisms present in the solution 101 are filtered and retained.

After filtering the microorganisms from the solution 101, the filtered sample flows through the cartridge 118. The filtered solution can leave the thermostatic chamber 114 by controlling the flow through a solenoid valve 106f. Then it flows through a dampener 121 that is located downstream of said valve 106f, and a flow sensor 122 downstream that senses the flow of the fluids leaving the thermostatic chamber. The filtered solution finally flows through a tubing 105i, ending in a residue container 125.

Once the microorganisms have been filtered in the filtering cartridge 117, then the device activates the pump 107c and opens the solenoid valve 106d. This way the measuring solution 104 is transported through tubings 105d and 105g, to the tubing 105h. The same way as with the sample solution 101, the device regulates the entrance of the measuring solution 104 to the thermostatic chamber 114 by controlling the flow through the solenoid valve 106e. The measuring solution 104 flows through the filtering cartridge 117 and enters in contact with the microorganisms priorly retained in the filtering cartridge 117. Once in contact with the microorganisms, the device proceeds to incubate the microorganisms retained in the cartridge 117 in the measuring solution 104. In order to do this, the device activates the thermostatic chamber 114, reaching a temperature of incubation as set by the user.

It shall be noted that the device automatically brings to temperature. The user can modify some of the operating conditions by accessing a menu. Such conditions comprise incubating temperature, incubating time, and volume of sample introduced. The device includes standard or preset values, as established in “use preset values”. However, a user can modify these conditions values according to the working conditions needed, and following an operation manual. The lid of the thermostatic chamber 114 preferably comprises a switch so that, if the lid is open, the heating system stops so as to prevent excessive heating of the components.

The incubation has as its main purpose to induce the reduction of a redox mediator by the active metabolism of the microorganisms priorly filtered from the sample solution. A person skilled in the art will be capable of determining the incubation time depending on the temperature of incubation, the measuring solution and the type of microorganism present in the sample.

Once the incubation is completed, the product of incubation flows through the electrode cartridge 118 of the present invention, where the electrochemical reaction is measured to determine the total TVM present in the sample solution 101. The measuring of the TVM is performed inside the thermostatic chamber 114, wherein the electrode cartridge 118 is connected to a potentiostat comprised by an electrochemical control module 120. Basically, the reduction of the redox mediator is released by the microorganisms present in the sample, and quantified inside the electrode cartridge 118, connected to the potentiostat. The higher the level of ferrocyanide measured, the higher the TVM present in the sample. Methods for determining the TVM are further exemplified in the Examples herein.

A vibrating bubble eliminator 116 eliminates bubbles that could be present in any of the solutions that flow through the fluidic system of the device of the present invention.

The flow of any fluid leaving the thermostatic chamber 114 can be regulated by controlling the flow through a solenoid valve 106f. A dampener 121 that is located downstream of said valve 106f that regulates the flow of the fluids, ensuring that said flow is constant and non-pulsating, and a flow sensor 122 downstream that senses the flow of the fluids leaving the thermostatic chamber. The liquid residues flow through a tubing 105i, ending in a residue container 125.

The function of the dampener of the device of the present invention is to decrease the pulsations of the fluids. The peristaltic pumps used in the device can cause pulsations in the flow, which can be detrimental to electrochemical measurements. In order to improve the accuracy of the measurements, the flow shall be constant, i.e. without pulses.

The flow sensor of the device of the present invention is part of the control and fault system; it allows the software to detect malfunctions, for example if the flow is very low or drops to zero when there should be flow, it indicates to the user a malfunction of the pumps or a clogging.

The filtering cartridge of the device of the present invention is, preferably, disposable, single-use, inexpensive, and can be discarded after measuring a single sample. In an embodiment, the filtering cartridge comprises a pore diameter preferably of 0.45 μm.

The device of the present invention also comprises a calibration system within the fluidic system. In order to calibrate the device, a calibrating solution 103 comprising a known concentration of redox mediator in any of its embodiments is used.

To calibrate the device of the present invention, the calibrating solution 103 is introduced in the device 100. Said calibrating solution 103 is connected by a tubing 105c to the pump 107b. The flow of said calibrating solution can be regulated by controlling the flow through a solenoid valve 106c. By activating the pump 107b and opening the solenoid valve 106c, the calibrating solution is transported through the tubing 105c and 105f to the tubing 105h.

The calibrating solution 103 goes through the bubble trap 111 that eliminates bubbles, and the pressure sensor 112 that senses the pressure of the liquids flowing through the tubing 105h. Then, the device regulates the entrance of the solution 103 to the thermostatic chamber 114 by controlling the flow through a solenoid valve 106e. The calibrating solution 103 flows through the filtering cartridge 117, then the calibrating solution 103 flows through the cartridge 118 of the present invention, where the electrochemical reaction is measured to establish an electrical signal that corresponds to the known concentration of the redox mediator.

After the electrochemical reaction, the calibrating solution can leave the thermostatic chamber 114 by controlling the flow through a solenoid valve 106f. Then it flows through the dampener 121 that is located downstream of the valve 106f, and the flow sensor 122 downstream that senses the flow of the fluids leaving the thermostatic chamber. The calibrating solution finally flows through the tubing 105i, ending in the residue container 125.

In an embodiment, the calibrating solution comprises a buffer, a redox mediator, and a salt. Preferably, the buffer is a PBS buffer, the redox mediator is ferricyanide and ferrocyanide, and the salt is sodium chloride. For example, and without intent to limit the scope of the present invention, the calibrating solution comprises
PBS, pH 7-0, 100 mM;
NaCl, 9 g/L;
K Ferrocyanide, 0.001-30 mM;
K Ferricyanide, 0.001-10 mM.

The device of the present invention also comprises a cleaning system within the fluidic system.

To clean the fluidic system of the present invention, a cleaning solution 102 is introduced in the device 100. Said cleaning solution 102 is connected by a tubing 105b to the pump 107a. The flow of said cleaning solution 102 can be controlled by a solenoid valve 106b. By activating the pump 107a and opening the solenoid valve 106b, the cleaning solution is transported through the tubing 105b and 105e to the tubing 105h.

The cleaning solution 102 follows the same steps hereon as those followed by the calibrating solution, except that no electrochemical reaction is performed and the calibration volume may be significantly superior to that used when analyzing samples.

In an embodiment, the cleaning solution comprises an alkaline salt, and a biocide agent. For example, KOH, or NaOH. In an embodiment, the cleaning solution may further comprise a degreasing compound, for example an acidic or neutral degreasing compound. For example, the cleaning solution comprises dipropylene glycol monomethyl ether.

The function of the cleaning solution is to remove oily or paraffinic debris that may enter the system as part of the samples, and to eliminate possible growth of microorganisms in the fluidic system.

The device of the present invention further comprises an electrochemical control module 120, that is located inside an electric noise insulator 119. Said module 120 comprises a potentiostatic module that controls an electrochemical cell, more particularly, a potentiostat. The potentiostat is connected to the electrode cartridge 118

Data-processing module 123 comprises a display touch 124 that the user can use to evaluate and control:
the flow rate of the peristaltic pumps, for example between 0.5-20 mL/min
the temperature of the thermostatic chamber, or example between 20-40° C.
the sensitivity of the system to better adapt to the amount of microorganisms present in a sample, for example between 105-10¹⁰ CFU/mL
the volume of a solution (sample, measuring, calibrating, cleaning) to introduce in the fluidic system, for example, between 0.1-100 mL
the incubating time, for example between 10 minutes-10 hours.

The device is electrically fed by a power supply module 108, comprising the power supply plug 110 and the On/Off switch 109, that controls the power supply to the device.

The device of the present invention further comprises an electronic control module 113 that comprises a computer that is connected to the electrochemical control module 120, the thermostatic chamber 114, the cartridge elevator system 115, the data-processing module 123, all the solenoid valves, all the peristaltic pumps, the pressure sensor 112, the flow sensor 122, the bubble trap 111 and the vibrating bubble eliminator 116.

In an embodiment, the electronic control module 113 may further comprise a USB data output, and a Bluetooth module.

Thanks to these connections, the computer controls the opening and closing of any one of the solenoid valves, the activation or deactivation of any one of the peristaltic pumps, the temperature of the thermostatic chamber, the flow rate of the peristaltic pumps, the display touch, the USB data output, and the Bluetooth module. The user can control these parameters through the display touch 124 to any particular conditions they find more suitable for the sample to analyze.

In an embodiment, the computer is further able to control the electrochemical control module, thus providing the potentiostat with information to carry out an electrochemical reaction in the electrode cartridge, and collect current information from the electrodes comprised therein. In an embodiment, the computer may also control the data processing module so as to, for example, obtain charge data from the currents measured at the electrodes, particularly, the working electrode.

The information of the activation or deactivation of any one of the peristaltic pumps, the temperature of the thermostatic chamber, the flow rate of the peristaltic pumps, the current consumed by the peristaltic pumps, is sent to the data-processing module 123 and the results of the TVM analysis are displayed to the user through the display 124.

In this way, the device of the present invention presents the following advantages over other similar devices present in the prior art:
thanks to the use of the microcontroller and single-board computer, that controls the different peripherals of the device of the present invention, the device can semiautomatically determine the total viable microorganisms (TVM) present in an unknown liquid sample;
thanks to the design of the fluidic system, and in particular the electrode cartridge 118, the device of the present invention can work with liquid samples in flow;
thanks to the use of a redox mediator-based reaction and a three electrode cartridge, the device of the present invention has the advantage of detecting a wider range of microorganisms than other devices in the state of the art.

The device is placed inside a suitcase 400, as shown in FIG. 4, comprising the following components.

| 106a. | Solenoid valve 1 (entrance) | 106f. | Solenoid valve 6 (exit) |
|---|---|---|---|
| 107a. | Peristaltic pump 1 | 107b. | Peristaltic pump 2 |
| 107c. | Peristaltic pump 3 | 109. | On/Off switch |
| 110. | Power supply plug | 112. | Pressure sensor |
| 114. | Thermostatic chamber | 400. | Suitcase |
| 401a. | Peristaltic pump support 1 | 401b. | Peristaltic pump support 2 |
| 401c. | Peristaltic pump support 3 | 402. | Suitcase lid |
| 403. | Thermostatic chamber display | | |

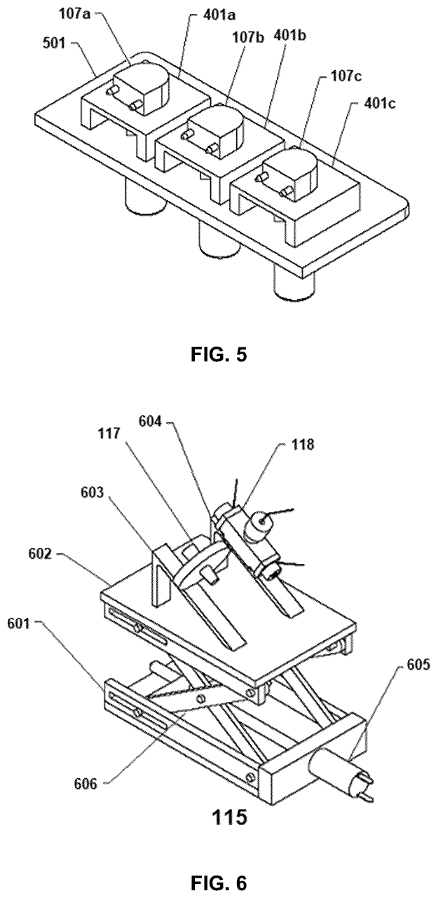

The device can be separated in three sectors as follows.
a first sector comprises the entire fluidic system comprising the peristaltic pumps 107a, 107b, 107c, the solenoid valves 106a, 106b, 106c, 106d, the peristaltic system support (see FIG. 5) comprising the peristaltic pump supports 401a, 401b, and 401c, the flow sensor, and the two reagent containers, containing sample solution 101 and the measuring solution 104,
a second sector placed immediately next to the first sector, that comprises the thermostatic chamber 114, as described above, further comprising a thermostatic display 403,
a third sector comprising the control electronics, the touch display 124, a single board computer, a potentiostat, power drivers, power supply module 108 comprising the power supply plug 110 and the on/off switch 109 and other necessary circuits. Alternatively, instead of a touch display, the third sector may comprise a non-touch display, and the device may further comprise means for connecting a mouse and/or a keyboard, which may in turn be wireless.

A suitcase lid 402 can be closed to protect the components of the device during its transportation and open for an access to the device when needed.

The following is a detailed description of a preferred embodiment of the peristaltic pump support as shown in FIG. 5. This is an exemplary embodiment, and it is not intended to limit the scope of the present invention in any way.

The peristaltic system support 501 comprises a platform, and over this platform three supports 401a, 401b, 401c are placed. The peristaltic pump 107a is placed over the peristaltic pump support 401a, the peristaltic pump 107b is placed over the peristaltic pump support 401b, the peristaltic pump 107c is placed over the peristaltic pump support 401c. The peristaltic supports, with their corresponding peristaltic pump over them, are placed next to the other in a way that they are all parallel to each other

The following is a detailed description of a preferred embodiment of the cartridge elevator system 115 as shown in FIG. 6. This is an exemplary embodiment, and it is not intended to limit the scope of the present invention in any way.

The cartridge elevation system 115 comprised by the device of the present invention comprises the following components:

| | | | |
|---|---|---|---|
| 117. | Filtering cartridge | 118. | Electrode cartridge |
| 601. | Elevator system fixing support | 602. | Cartridge elevator platform |
| 603. | Filtering cartridge fixing | 604. | Electrode cartridge fixing |
| | system | | system |
| 605. | Elevator motor | 606. | Scissor-type elevator |

The way the components of the cartridge elevation system 115 interrelates with each other is described as follows:

The cartridge elevator system 115 consists of an elevator fixing support 601 and a cartridge elevator platform 602, connected to each other by the means of two scissor-type elevators 606. This scissor-type elevator is driven by a motor 605. On top of the platform 602, there is a filtering cartridge fixing system 603 that fixes the position of the filtering cartridge 117, and a electrode cartridge fixing system 604 that fixes the position of the filtering cartridge 118.

In an alternative embodiment, the thermostatic chamber 114 is larger, and it is therefore not necessary to include a cartridge elevator.

In a preferred embodiment, the filtering cartridge 117 is fixed to filtering cartridge fixing system 603, and the electrode cartridge 118 is fixed to the electrode cartridge 604 by means of a magnet. In an embodiment, the filtration cartridge 117 and the electrode cartridge 118 are not placed horizontal relative to the platform 602. Preferably they are placed with an angle between 0-90°, more preferably in a 45° angle.

In an embodiment, the motor 605 can be activated by the user to elevate or descend the platform 602. In a particular embodiment, the elevation and/or the descend of the platform 602 are performed automatically by the computer.

The cartridge elevator system 115 as a whole is located within the thermostatic chamber 114 of the device of the present invention. When the platform 602 is located at its lowest point, it is placed within the thermostatic chamber 114, and when the platform 602 is at its highest it can be outside the thermostatic chamber 114, for ease of access to the electrode cartridge.

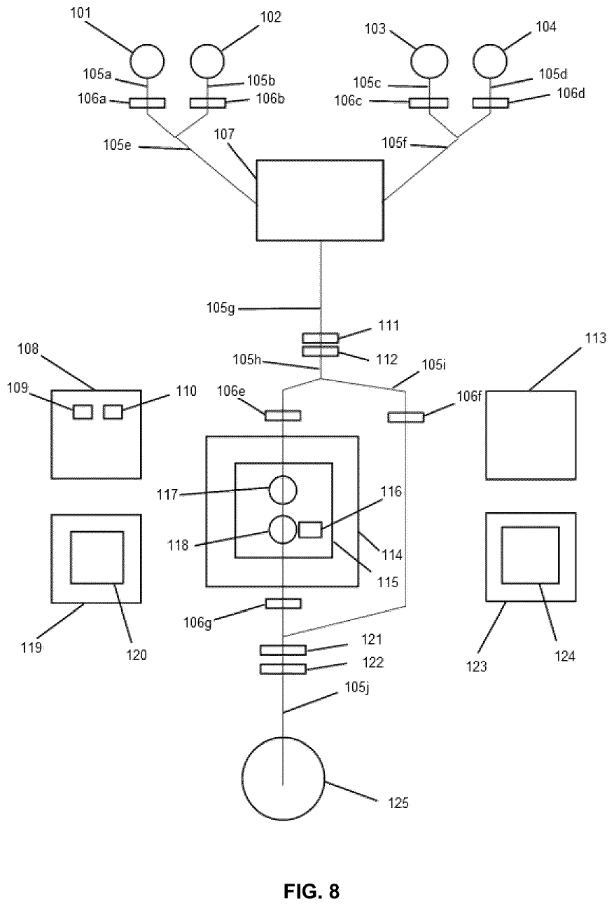

In another configuration of the device of the invention, the device comprises a single peristaltic pump, which has the advantage of avoiding the effects of a potential lack of calibration of two or three peristaltic pumps. In this configuration, so that a single pump may be able to propel the different flows in the device, a stepper motor pump is preferably used. FIG. 8 provides a schematic depiction of the configuration with a single peristaltic pump.

In such a configuration, a sample solution 101 preferably comprising microorganisms in any of the embodiments of the present invention is introduced in the device 100. Said sample solution 101 is connected by a tubing 105a/105e to a pump 107. The flow of said sample solution 101 can be regulated via the activation of the pump 107 and by opening a solenoid valve 106a.

A measuring solution 104 comprising a redox mediator in any of the embodiments of the present invention is introduced in the device 100, separated from the sample solution 101. Said measuring solution 104 is connected by a tubing 105d/150f to a pump 107. The flow of said measuring solution 104 can be regulated via the activation of the pump 107 and by opening a solenoid valve 106d.

By activating the pump 107 and opening the solenoid valve 106a, the sample solution 101 is transported through the tubing 105a and 105e, to the pump 107. The sample solution 101 goes through a bubble trap 111 that eliminates bubbles, and a pressure sensor 112 that senses the pressure of the liquids flowing through the tubing 105g. The device can regulate the entrance of fluids to a thermostatic chamber 114 by controlling the flow through solenoid valves 106e or 106f.

When solenoid valve 106f is open, solution 101 is disposed to residue container 125 without passing through cartridges 117 and 118, allowing to purge the solutions present in tubing 105g-j, allowing the measurement of the sample chosen, the solution 101. This is especially important when a new sample is measured, this step allows the elimination of the previously measured sample present in tubing 105g-j.

When the fluid circuit is purged, solenoid valve 106f is closed, and solenoid valve 106e is opened. Then, solution 101 enters a thermostatic chamber 114 and flows through filtering cartridge 117, where microorganisms present in the solution 101 are filtered and retained.

After filtering the microorganisms from solution 101, the filtered sample flows through electrode cartridge 118. The filtered solution can leave the thermostatic chamber 114 by controlling the flow through a solenoid valve 106g. Then it flows through a dampener 121 that is located downstream of said valve 106g, and a flow sensor 122 downstream that senses the flow of the fluids leaving the thermostatic chamber. The filtered solution finally flows through a tubing 105j, ending in a residue container 125.

Once the microorganisms have been filtered in filtering cartridge 117, the device activates pump 107 and opens solenoid valve 106d. This way, measuring solution 104 is transported through tubings 105d and 105f, to pump 107. The same way as with sample solution 101, the device regulates the entrance of measuring solution 104 to thermostatic chamber 114 by controlling the flow through solenoid valve 106e whereas solenoid valve 106f remains closed. Measuring solution 104 flows through filtering cartridge 117 and enters in contact with the microorganisms priorly retained therein. Once in contact with the microorganisms, the device proceeds to incubate the microorganisms in measuring solution 104. In order to do this, the device activates thermostatic chamber 114, reaching an incubation temperature as set by the user.

### Method for Determining TVM in a Sample

As mentioned above, the electrode cartridge and device of the present invention may be used for the determination of viable microorganisms present in a liquid sample by means of electrochemical measurements. Correspondingly, it is an aspect of the present invention to provide a method for determining the total viable microorganism (TVM) present in a liquid sample, comprising the steps of
a) obtaining a liquid sample containing microorganisms in suspension,
b) filtering the microorganisms present in the sample of step a),
c) cultivating the microorganisms obtained in step b) in a solution comprising redox mediators,
d) carrying out a reduction of the mediators with the microorganisms obtained in step b),
e) introducing the product of the reaction of step d) in an electrode cartridge of the first aspect of the invention,
f) oxidizing the product of the reaction of step d) in the electrode cartridge of the first aspect of the invention,
g) producing an amperometric signal via the oxidation reaction of step f), and
h) calculating the TVM present in the liquid sample of step a) from the amperometric signal of step g).

The following is a further embodiment of the method for determining the total viable microorganisms (TVM) of the present invention defining preferred embodiments thereof.

In an embodiment, the liquid sample of the step a) comprises liquid samples of different origins and characteristics, such as fresh, brackish, salty or hypersaline water, of subterranean, superficial continental or marine origin. These samples may contain a variety of other components, such as petroleum and petroleum derivatives, particulate material, heavy metals, turbidity originated by suspended material or high content of organic matter, for example sewage liquids or different agents that may give color or odor. Other types of samples can be liquid foods of different origins (yogurts and other fermented foods), sauces, mayonnaise, among others. Solid or semi-solid samples such as culture soil, industrial sludge, activated sludge, underwater soils in lakes, rivers or seas, can be measured by dilution, suspension or extraction with liquid media based on buffered aqueous saline solutions.

In an embodiment, the filtering of the microorganisms of step b) takes place inside the filtering cartridge.

The solution of step c) further comprises a nutrient solution. In an embodiment said nutrient solution comprises a carbon source, a buffer, salts, a redox mediator and, optionally, a second fat-soluble mediator. For example, and without intent to limit the present invention, the solution of step c) comprises:
a carbon source, comprising acetate, lactate or any combination thereof;
a buffer, comprising Na₂HPO₄, KH₂PO₄, NaHCO₃, or any combination thereof;
a salt, comprising CaCl₂), MgCl₂, NaCl or any combination thereof;
a redox mediator, comprising K ferricyanide;
a second fat-soluble mediator, comprising menadione.

An important advantage of using such a nutrient solution in comparison to ATP-based methods is that during the incubation period the microorganisms are provided with a carbon source, which allows the activation of the metabolism of dormant cells that have a very low metabolic activity, and are usually underestimated or undetected by ATP-based methods.

It should be noted that the exact nutritional composition of the solution of step c) can vary depending on the type of sample to be analyzed. A person skilled in the art would be capable of determining the components of the solution depending on the nature of microorganisms expected in the analyzed sample.

Nutrients can also be incorporated using dehydrated media commonly used for the cultivation of microorganisms, such as LB medium and others, based on the combination of materials such as soybean extract, meat extract, soy protein hydrolysates, other hydrolysates, and other organic and inorganic components.

In an embodiment, the culturing of the microorganisms of step c) is performed during 5-600 minutes, preferably 15 minutes, at a temperature of 20-45° C., preferably 35° C., and at a pH between 2-9, preferably 6. Thus, the reduction of the mediators of step d) takes place.

In a preferred embodiment, the steps b), c), d), e) and f) are performed inside the thermostatic chamber 114 of the device of the present invention. Preferably in a temperature between 20-45° C., preferably 35° C.

The amperometric signal produced in step g) of the method is typically a measurement of current intensity in time (chronoamperometry), from which two parameters may be determined: peak intensity and charge (the latter determined as the area below the intensity curve obtained in the measurement). Both parameters will be related to the amount of reduced mediators produced during the incubation of the microorganisms, which is in turn related to the amount of TVM present in the original sample. Correspondingly, the amperometric signal may be used to calculate the amount of TVM present in the sample, as recited in step h) of the method.

In an embodiment, the device of the present invention can be used to determine microorganisms and groups of microorganisms that can be responsible for damaging metal structures, or cause microbially induced corrosion (MIC). The following list highlights some exemplary organisms or groups of organisms, preferably, groups of bacteria, although other archaea, fungi and yeasts can be responsible for damage to metal structures.

### Acid Producing Bacteria

Acid producing bacteria are capable of producing organic and inorganic acids which can significantly drop the pH beneath the biofilm into the acid range. Under these conditions, an acid-driven form of corrosion can occur causing metals to dissolve and concrete structures to lose integrity. These acidic metabolic by-products are produced under very reductive (oxygen free) environments. The sulfate reducing bacteria are often found within this nutrient rich, oxygen free environment.

Telltale signs of acid producing bacteria corrosion include, but are not limited to, pitting corrosion and pinhole leaks.

Types of water/sources that may be tested include: hot and cold water distribution systems, open and closed recirculating heating and cooling systems, water-based fire protection sprinkler systems, and water-based fracturing fluids in gas and oil industry.

### Iron Related Bacteria

Iron related bacteria include both iron oxidizing and iron reducing bacteria. These bacteria function under different reduction-oxidation (redox) conditions and utilize a variety of substrates for growth. This consortium is complex and includes stalked and sheathed bacteria as well as heterotrophic and slime forming bacteria. Examples of this group include: Gallionella, Crenothrix, Sphaerotilus, Siderocapsa, Thiobacillus and Pseudomonas.

The iron-utilizing bacteria can be problematic in that they can cause corrosion of iron and steel. This process can cause pitting of the metal surface, resulting in pin hole leaks. These bacteria can also accumulate iron to the point where the growth becomes a hard encrustation or tubercle. Over time these deposits can reduce water flow and affect system performance.

Types of water that can be tested include: potable water plumbing systems, cooling towers, heat exchangers, water heaters, and water based fire protection sprinkler systems.

### Slime Forming Bacteria

The slime forming bacteria is the name given to a group of bacteria that are capable of producing a variety of extracellular polysaccharide polymers. It is these long chain molecules which act as the foundation and cement for the formation of biofilm. The slime-like growth coating the inside of pipes and fixtures is called the biofilm. The purpose of this slime layer appears to be protective. Under harsh environments (e.g., temperature changes, chemicals, shortage of nutrients) slime layers can get thicker. As the biofilm matures, aerobic bacteria creating the biomass produce metabolic by-products all the while consuming oxygen. This facilitates micro-environments underneath the biofilm which can then support the growth of anaerobic bacteria. The slime forming bacteria are an important part of the microbial influenced corrosion process in that they can function under different reduction-oxidation conditions. This transition of aerobic to anaerobic environments within the biofilm supports the growth of iron related, sulfate reducing and acid producing bacteria.

The slime producing bacteria can cause engineering problems related to the reduction of hydraulic or thermal conductivity as well as clogging, taste, odor and color changes.

Types of water sources that may be tested include open-evaporative cooling systems, water-based fire protection sprinkler systems, condensers, and well water.

### Sulfate Reducing Bacteria

This test is specific for sulfate reducing bacteria such as Desulfovibrio, Desulfomonas and Desulfotomaculum. These bacteria require metal ions as a source of energy and produce hydrogen sulfide as an end result. They are probably the most destructive group of bacteria causing microbial influenced corrosion. Detection of these bacteria can be problematic. They are strict anaerobes and grow deep within biofilms. In fact, sulfate reducing bacteria may not be present in the free-flowing water over the site of the fouling. Their presence relates to corrosion problems, taste and odor problems (“rotten egg” odors), and blackened waters. Slimes rich in sulfate reducing bacteria tend to also be black in color.

Types of water sources that may be tested include: oxygen-deficient environments such as deep wells, plumbing systems, water softeners and water heaters; condensers.

### EXAMPLES

The following Examples are a detailed description of a preferred embodiment of the different components of the device of the present invention. These are exemplary embodiments of the different aspects of the present invention and are not intended to limit the scope of the present invention.

### Example 1: Exemplary Components of the Device of the Present Invention

The equipment is contained within a rigid case resistant to shock, water and dust, commonly used for carrying delicate items or portable analytical equipment. For this purpose, an internal structure was designed to fix all the necessary components.

The internal structure comprises a structural aluminum frame type Bosch 2020, with accessory brackets and special M5 screws. This frame provides the base for fixing 5 mm thick acrylic panels. In a preferred embodiment, a transparent acrylic is used in order to be able to observe the whole operation and to facilitate the detection of problems.

The device of the present invention can be divided into 3 sectors:
A first sector comprises a fluidic system comprising peristaltic pumps, pinch valves, flow sensor and the two reactive containers.
A second sector comprises a thermostatic chamber, an ISOLANT thermally insulated box of aluminized insulating foam, containing a microbial incubation cell and a filtration cell. It also contains an electronic thermostat and a forced air recirculation control.
A third sector comprises control electronics, a single board computer, a potentiostat, power drivers, power supply module and other necessary circuits.

Each of the sectors may be covered by a top acrylic panel that functions as a lid and has access holes. This lid may be removable and can be attached with magnets or controls to operate the equipment.

At the bottom of the case there is a free space to act as a containment unit in the event of a fluid spill. There is also a drain valve to drain any spilled fluids.

### 1.1 Description of the Quick Coupling Fluidic and Peristaltic Pump Subsystem for the Collection of Liquid Samples

Peristaltic pumps (PB): In a preferred embodiment, the PBs for the device of the present invention are those with six rollers, 12 VDC, to allow speed control by PWM technique and which allow flow rates of at least 1 to 20 ml/min to be achieved. In contrast, three-roller PBs generate an excessive pulsing effect which can cause problems in the flow sensor and the analytical technique. Although the pulsation effect is much less in the six-roll PBs, it still persists, so a damper is added to add an additional length of pipe. In the case of the device of the present invention, for the measurements and flow rates used, it is observed that 30 cm of extension per branch has a significant impact on the quality of the measurements.

The Kamoer® KCS-B14-SD6 peristaltic pump is particularly selected for the device of the present invention in the three-pump configuration. When using the single pump configuration, a stepper motor pump is preferably used, such as Kamoer® KCS-B14-SD6.

As a quick coupling system for the connection of the reagents to the collapsible containers, various models were investigated, and it was concluded that the most suitable systems for the device of the present invention are the Luer type connections. This coupling system allows a safe and loss-free coupling for small flow rates. Luer type couplings consist of two standards: ISO 594-1 and ISO 594-2.

As mentioned above, a flow sensor is necessarily incorporated in the overall system schematic. This allows a closed-loop control of the system. For the device of the present invention, it was chosen to use a thermo-differential sensor, whose operation is based on thermal transfer. This sensor has a digital output calibrated by I2C bus, which allows it to be linked to a single board computer and transmits its measurement in real time.

Solenoid valve: The use of a solenoid valve, in particular the model HP20-INC32 from Hontai Machinery and equipment (HK) co. has been chosen for the device of the present invention. An alternative model which may be used is YNV-015, obtained from Lucky® (Shanghai, China).

Flow sensor: The flow sensor selected for the device of the present invention is the model SLF3S-1300F Liquid Flow Sensor, from Sensirion. This sensor provides accurate and reliable measurements of dynamic liquid flows up to 40 ml/min. The sensor is bi-directional, has a digital output via I2C interface with a standard 6-pin connector. It consists of a high-precision CMOSens sensor chip, which combines the sensor element, signal processing and digital calibration on a single chip.

The sensor was integrated with an Atmel microcontroller and other associated components to make the quadalimeter autonomous, linking with the single-board computer through the I2C bus, which has a system for the acquisition and control of almost all the peripherals. The firmware developed allows independent calibration curves for each fluid used in the system in order to have the highest possible accuracy. The sensor has a bubble detector, a condition which, if it occurs, is reported to the single-board computer so that the necessary actions can be taken.

Thermostatisation system with adjustable temperature: The system is based on a resistive system for heating and performing the incubation of the sample. The system is equipped with an I2C communication interface. In addition, the system has an OLED display to visualize the temperature and set point of the thermostatic unit at any time.

EIS-capable potentiostat: The device comprises an EmStatPico potentiostat module, a chip of Analog Devices that integrates the potentiostat with an integrated EIS.

These sub-systems are resolved at the fluidic level by the pump and connectors described herein, plus an outlet solenoid valve, which is described below.

The device of the present invention comprises a flow sensor that enables a closed-loop control of the system. In a particularly preferred embodiment, said sensor is a thermo-differential sensor based on thermal transfer. This sensor has a calibrated 12C bus digital output so it can be linked to a single-board computer and transmits its measurements in real time.

Flow Sensor. The device of the present invention comprises a flow sensor that's suitable for its use in the device. The flow sensor model selected is the SLF3S-1300F Liquid Flow Sensor, from Sensirion.

This sensor provides accurate and reliable measurement of dynamic liquid flow rates up to 40 ml/min, which is ideal for the range of the measurements required. The sensor is bi-directional, has a digital output via I2C interface with a standard 6-pin connector. It is built with a high-precision CMOSens sensor chip. This technology combines the sensor element, signal processing and digital calibration on a single chip. It is ideal for original equipment manufacturing (OEM) applications, i.e. components that are designed to be integrated into equipment designed and manufactured by other.

The sensor was integrated with an Atmel microcontroller and other associated components so that the flow meter module is autonomous, linking up with the single-board computer via the I2C bus that the system has for the acquisition and control of the peristaltic pumps and the solenoid valves. The firmware developed also allows independent calibration curves for each fluid used in the system, in order to have the best possible accuracy. The sensor has a bubble detector, a condition which, if it occurs, is reported to the single-board computer so that the necessary actions can be taken.

### Filtration Cartridge:

A 30 mm diameter commercial syringe filter cartridge. NY filter material, 0.45 μm pore, with 1 micron GF prefilter.

### Electrode Cartridge:

The electrode cartridge is a non-commercial element designed by the inventors, with an electrochemical active area between 0.5-25 m² in an electrode comprising 3 discs and these discs being made of a porous carbon felt. It has been manufactured with 3 carbon felt discs as working electrode (WE) and counter electrode (CE) (three discs for each electrode), titanium wire as current collector for WE and CE, and 0.5 mm Ag wire chlorinated in 3M KCl solution as reference electrode (RE). It has three Luer type connectors for input, output and RE, and a standard connector for the connection of the three electrodes to the potentiostat.

1.2 Operation and measurement of electrochemical cell using EmStat Pico potentiostat.

### EIS-Capable Potentiostat:

In order to compatibilize the potentiostat with the Sésil module, which will be integrated in the same case sharing resources, it is necessary to have a particular electrochemical technique known as “EIS” (Electrochemical Impedance Spectroscopy).

A chip from Analog Devices was selected, which integrates a potentiostat with integrated EIS, of reasonable cost and specially created for integration in larger systems and control via a serial interface (I2C or SPI). The chip works in programming languages such as C or Python.

The EmStat Pico is a dual-channel stand-alone potentiostat module, which allows electrochemical measurements using self-developed software. This product is a joint development of Analog Devices and PalmSens. These modules are factory tested and calibrated. The specific model is the “EmStat Pico Module” from PalmSense.

1.3 Software (Code and Libraries) that Handles Peristaltic Pumps, Solenoid Valves, and the Potentiostat.

The Software selected for the device of the present invention is Raspberry Pi 3B+. This software was migrated to the new platform. In principle, this would only require the remapping of GPIO pins.

In order to take full advantage of the hardware possibilities, it was decided to modify some aspects of the software. Basically, the aim is to simplify the wiring, which reduces the possibility of electrical interference, and to take advantage of the extra input/output pins (GPIOs) of this module. This simplifies the software by reducing resource sharing.

### Example 2: Preparation of the Different Solutions

### 2.1 Preparing the Measuring Solution

Prepare the PBS separately so that not so much salts precipitate. Prepare solutions 1, 2 and 3 separately.
Adjust to pH 6.0; must be sterile
By combining the three solutions, approx. 500 of the final solution is obtained, called “Original Measuring Medium”, in blue the variable “Measuring Medium Low Salt” is shown.

### Saline Solution+Carbon Sources (Solution 1)

| | Original | | | Low salt | |
|---|---|---|---|---|---|
| | medium | | | medium | |
| | weighing for | | | weighing for | |
| | 500 mL final | Concen- | | 500 ml final | Concen- |
| Reactive | volume | tration | mM | volume | tration |
| CaCl₂ 2H₂O | 3.50 g | 7 g/L | | 0.1 g | 0.2 g/L |
| MgCl₂ 6H₂O | 1.50 g | 2 g/L | | 0.05 g | 0.1 g/L |
| NaHCO₃ | 1 mg | 20 mg/L | | 10 mg | 20 mg/L |
| Na Acetate | 0.5 g | 1 g/L | 12 | 0.5 g | 1 g/L |
| Na Lactate | 0.4 mL | 0.8 g/L | | 0.4 mL | 0.8 g/L |

Bring to 400 mL with distilled water, dissolve, adjust pH to 6.0, and autoclave

### Saline Phosphate Buffer (Solution 2)

| | Original | | | Low salt | |
|---|---|---|---|---|---|
| | medium | | | medium | |
| | weighing for | | | weighing for | |
| | 500 mL final | Concen- | | 500 ml final | Concen- |
| Reactive | volume | tration | mM | volume | tration |
| NaCl | 3.85 g | 7.7 g/L | | 3.85 g | 7.7 g/L |
| Na₂HPO₄ | 2.75 g | 5.5 g/L | | 2.75 g | 5.5 g/L |
| KH₂PO₄ | 4.7 g | 9.4 g/L | | 4.7 g | 9.4 g/L |

Bring to 400 mL with distilled water, dissolve, adjust pH to 6.0, and autoclave

### Redox Mediator Solution (Solution 3)

| | Original | | | Low salt | |
|---|---|---|---|---|---|
| | medium | | | medium | |
| | weighing | | | weighing | |
| | for | | | for | |
| | 500 mL | | | 500 ml | |
| | final | Concen- | | final | Concen- |
| Reactive | volume | tration | mM | volume | tration |
| K | 3.28 g | 6.56 g/L | 20 mM | 3.28 g | 6.56 g/L |
| ferricyanide | | | | | |
| Menadione | 14 mg | 28 mg/L | 160 μM | 14 mg | 28 mg/L |

Dissolve the menadione in 1 mL of ethanol, then mix.
Bring to 50 mL with distilled, it is added sterilizing by filtration, filter 0.22 microns. This is done in laminar flow, so as not to contaminate solutions 1 and 2, already sterile by autoclaving.

Mix solutions 1 and 2 in sterile (laminar flow) a little at a time with manual agitation. Add solution 3 using a syringe filter to sterilize solution 3.

Mix, purge with nitrogen for 25 minutes and allow to precipitate what precipitates, about 5 minutes.

Two bags of saline solution are used, emptied until completely collapsed (empty of liquid and air) and washed 3 times with nitrogen (100 mL of nitrogen each time, fill, and empty completely, repeat 3 times).

The collapsed bags are then filled with half of the measurement medium preparation, about half each. The bags should have a chamber of about 100 mL of nitrogen, with room for the ice to expand (slack).

Each bag is placed in a Zip-Loc bag well flushed with nitrogen. It is closed with the Zip-Loc fastener and reinforced by closing it with insulating tape (the kind used in electricity) to strengthen the closure.

### 2.2 Preparation of Calibrating Solution

| | Weighing for 500 mL | | |
|---|---|---|---|
| Reactive | final volume | Concentration | mM |
| NaCl | 3.85 g | 7.7 g/L | |
| Na₂HPO₄ | 2.75 g | 5.5 g/L | |
| KH₂PO₄ | 4.7 mg | 9.4 mg/L | |
| K ferricyanide | 3.28 g | 6.56 g/L | 20 mM |
| K ferrocyanide | 21 mg | 42 mg/L | 0.1 mM |

Bring to 50 mL with distilled water, dissolve, adjust to pH 6.0, and autoclave

### 2.3 Washing Solution

When the equipment is put away, either after a certain number of determinations or at the end of the working day, a solution that washes, degreases and has a biocidal action will be circulated through the equipment in an automatic process that lasts about 10 minutes, to leave the entire fluidic circuit of the equipment (especially where the samples circulate, since the solutions used by the equipment do not cause problems and are sterile) clean, and to prolong the useful life of the tubing and electrode cartridge.

Physiological saline solution, with the addition of

| Reactive | Concentration | mM |
|---|---|---|
| NaOH | 2.0 g/L | |
| Na₂HPO₄ | 3 ml/L | |
| Na hypochlorite | 50 mL/L | (5%) |

Bring to 50 mL with distilled water, dissolve, adjust to pH 6.0, and autoclave.

It has been observed that an industrial washing solution has the following composition: sodium hydroxide 7%—dipropylene glycol monomethyl ether (DME) 10% (grease and lacquer solvent)—nonionic surfactant. And it is proposed for use at 1:20 in water for very stubborn dirt, 1:40 for normal dirt, and 1:60 for maintenance.

### Example 3: Evaluation of Electrical Conductivity (EC) and pH of the Samples

For the determination of EC, a portable digital conductivity meter, Oakton model Acorn CON 6+, with automatic temperature compensation.

Since the samples are highly saline, an Oakton conductivity/temperature probe with a constant K=1.0 cm⁻¹ was used. This probe can be used to determine EC with the following characteristics:
Conductivity ranges 0 to 20.00 μS; 0 to 200.0 μS; 0 to 2000 μS; 0 to 20.00 mS; 0 to 200.0 mS.
Resolution: 0.01 μS; 0.1 μS; 1 μS; 0.01 mS; 0.1 mS. Accuracy: +1% full scale.

In all cases the units correspond to microS (μS) or milliS (mS)×cm⁻¹. Merck paper strips were used for pH determinations, pH range: 0-14.

Additionally, and for comparison purposes, EPF5 and GBK 1024 samples were analyzed.

TABLE 1

| | | CONDUCTIVITY | |
|---|---|---|---|
| SAMPLE | ORIGINAL TAG | (mS/cm) | pH |
| A | ID = 2079 YT.112.000851 | 118.3 ± 6.2 | 6-7 |
| B | ID = 2077 YT.112000851 | 117.5 ± 2.8 | 6-7 |
| C | TR 15251 P | 124.25 ± 7.0 | 7 |
| D | GBK 1024 | 43.4 ± 7.2 | 8 |
| E | SDQTK253SPCC9 (47.8° C.) | 71.0 ± 2.8 | 6-7 |
| F | SdAPCl Oct. 1, 2022 | 158.1 ± 2.5 | 6-7 |
| G | TKGO-PCC No13 (32.2° C.) | 12.7 ± 1.4 | 7 |
| H | Agua EPF5 5/8 PCC No7 1578 | 145.7 ± 1.3 | 4.5 |
| I | 87060 TK | 18.5 ± 1.1 | 7-8 |
| EPF5 | EPF5 | 200.2 ± 6.2 | 6-7 |
| GBK 1024 | GBK 1024 | 41.6 ± 2.8 | 7-8 |

Electrical conductivity (EC) and pH values of the analyzed sample

### Example 4: Comparative Assay Between the TVM Detection Method of the Present Invention and the ATP (Luminescence) Detection Assay

Tests were performed with the electrochemical method of the present invention and compared with the system based on ATP detection.

To carry out the ATP-based method, microorganisms were separated from a sample by filtering. The microorganisms are then lysed and then, by means of an enzymatic reaction that releases light, the luminescence is measured, which is related to the ATP concentration, which is proportional to the TVM concentration. Prior to the measurement, an ATP standard curve is performed to calibrate the luminescence vs ATP concentration system.

In the case of the method of the present invention, microorganisms are first separated from a sample by filtration, then these are washed with a nutrient solution, free of oxygen, containing ferricyanide, which diffuses into the cells where it is reduced to ferrocyanide by microbial metabolism, and then said ferrocyanide is measured on the surface of an electrode. It is not necessary to lyse the cells in order to carry out this measurement. The ferrocyanide produced is then measured by chronoamperometry and the current (or charge) produced is used to calculate the amount of TVM. Prior to the measurement, a ferrocyanide standard curve is made to calibrate the system peak current (or charge, by integrating the peak area, ixt) vs. ferrocyanide.

### Example 5: Calculation of CFUs Using the Amount of Ferrocyanide/Hour Produced

### 5.1 Measurements

Relatively low flow volumes (0.5 mL/min) were used during these experiments.

The measurement sequence consists of measuring a standard (calibrating solution, containing 0.1 mM ferrocyanide) followed by the different samples. The conditions used for all samples were:
Measuring solution (see Example 2, point 2.1)
Volume of filtered sample: 10 mL
Incubation time: 15 minutes
Incubation temperature: 35° C.

The quantitative test was carried out by measuring the amperometric peak current (peak current). The difference between the peak current reached and the baseline was taken. This procedure is dependent on the flow rate of the peristaltic pumps. For this test, the amount of ferrocyanide produced by an “average” microorganism is estimated during a 15-minute incubation under the conditions priorly estimated, and said value is used to estimate the total number of microorganisms based thereon.

### 5.2 Calculation of CFUs Using the Amount of Ferrocyanide/Hour Produced.

The EPF-5 from a 20 L drum was found to contain 9.4×10⁶ microbial equivalent (ME)/mL by the ATP test. The same sample by the ferricyanide method, during the 15 minutes incubation, yielded a concentration of 71.5 M ferrocyanide. The volume in which this concentration is found is estimated to be 1 mL (this would be the internal volume of the filtration cartridge, plus dilution and diffusion that affects the concentration until the electrode cartridge is reached.

Considering this concentration and this volume (71.5 μM, and 1 mL), it is estimated the synthesis of 71.5 nanomoles of ferrocyanide in 15 minutes, or the equivalent 286 nanomoles/hour.

By dividing the nanomoles produced in 15 minutes of incubation by the amount of TVM in the sample (calculated according to the ATP test), it is calculated an amount of ferrocyanide produced by 1 microbial equivalent during a 15-minute incubation under the assay conditions (incubation temperature, medium).

This factor is then calculated as 71.5/9.4×10⁶=7.61×10⁻⁶, the latter value is the amount of ferrocyanide produced by a single viable microorganism. This factor may vary in different types of samples and microorganisms.

### 5.3 Results Obtained Using the ATP Test

The results obtained are presented, the procedures were performed as detailed in the operation manual provided by LuminUltra, using the commercial equipment (PhotonMaster™ luminometer) and tests provided by this company.

TABLE 2

| | | | Deviation |
|---|---|---|---|
| SAMPLE | ORIGINAL TAG | Mean ME/mL | (ME/mL) |
| A | ID = 2079 YT.112.000851 | 7.20E+06 | 2.00E+05 |
| B | ID = 2077 YT.112000851 | 6.80E+06 | 1.00E+05 |
| C | TR 15251 P | 5.50E+06 | 1.00E+05 |
| D | GBK 1024 | 9.40E+05 | 5.00E+04 |
| E | SDQTK253SPCC9 (47.8° C.) | 5.50E+05 | 4.00E+04 |
| F | SdAPCl Oct. 1, 2022 | 2.70E+06 | 2.00E+05 |
| G | TKGO-PCC No13 (32.2° C.) | 1.60E+06 | 2.00E+05 |
| H | Agua EPF5 5/8 PCC No7 1578 | 2.00E+03 | 5.00E+02 |
| I | 87060 TK | 2.30E+06 | 1.00E+05 |
| EPF5 (1) | EPFS original | 9.40E+06 | 4.00E+05 |

ATP test result.
ME = Microorganism equivalent.

### Example 6: Current Measurements with the Device of the Present Invention

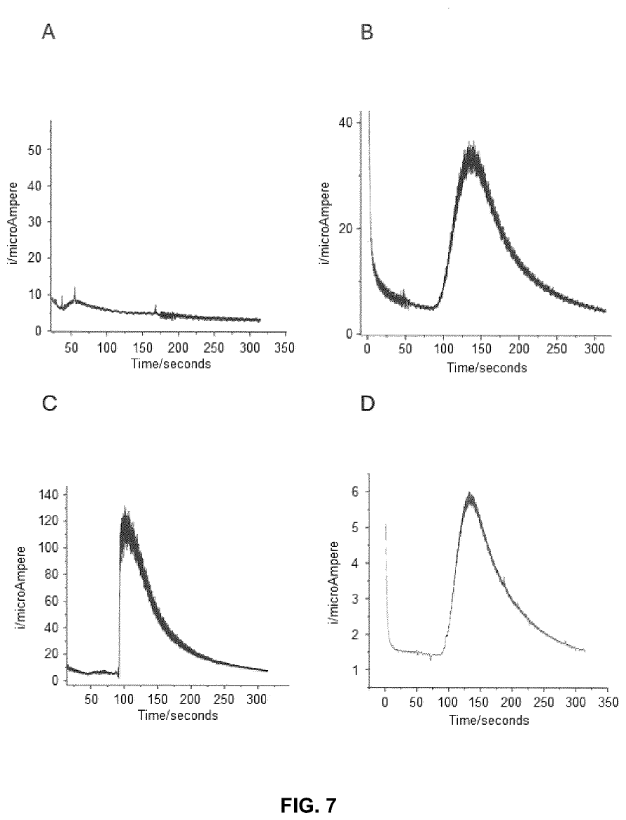

Different current vs time responses are summarized in FIG. 7 herein. The analytical signal is typically obtained in two ways, 1) by measuring the maximum peak current, and/or 2) by measuring the accumulated charge under the (i×t) curve.

The presented results show exemplary signals typically obtained during the measurement of standards, simulated samples and real samples; depending on the variable setting the shape of the signals may change. The presented graphs are not intended to limit the scope of the present invention.

### Example 7: Manufacturing of the Electrode and Device of the Present Invention

The electrode cartridge compartment 204 is made of a plastic transparent material, by injecting said plastic in a matrix with the proper shape, producing two halves of the electrode cartridge compartment.

A titanium wire holds up three carbon felt discs by introducing said wire through them, as shown in FIG. 1 and FIG. 2. Then the wire is introduced inside the electrode cartridge chamber, dragging the three carbon felt discs into it. The process is repeated for the second half of the electrode cartridge.

Once the two halves are properly loaded, these are sealed using a glue. The holes through which the titanium wires are introduced are sealed in the same way. By sealing the two halves, three openings are generated: the first and second opening are located in opposite ends of the compartment on a longitudinal axis, and the third opening is located perpendicular to the other two openings. A Luer connector is then introduced into each of the tree openings, generating an entrance Luer connector 201a, an exit Luer connector 201b, and an adapter Luer connector 201c.

A reference electrode 207 is manufactured using a silver coated wire, or silver, which has been treated to form silver chloride on its surface. This chloride-coated wire is inserted into the reference electrode compartment 303 and a porous connector 302 (made of vicor glass, other porous glasses, porous ceramics, paper or compressed cotton) added to the bottom of the electrode compartment 303, which allows the filling of the reference electrode compartment 303 (a solution of KCl at a concentration between saturation and 0.1 M) to flow at low velocity.

This section containing the chloride silver reference electrode has a connector that is complementary to the Luer connector of the third opening of the compartment. In this way it is attached to the electrode cartridge compartment and sealed to prevent leakage. The silver wire, unchlorinated, protrudes from the top of the section. In both the titanium and silver wires that protrude from the cartridge, a suitable electrical connector is placed to simplify the connection with the equipment and the electrochemical measurements.

### Example 8: Field Assay Using a Device According to the Present Invention

A field assay was performed in an oil field with tertiary extraction. For 5 consecutive days, about 50 samples from different steps of the process were measured, wherein the microorganisms content varied between 105 and 107 TVM/mL, depending on the facilities sampled.

The samples were taken each morning, and then measured simultaneously with a device according to the present invention, with the components and functioning parameters as described in the previous Examples, and with a commercial ATP-based device (Quench-Gone™ Aqueous Test Kit, form LuminUltra kit, measured with the PhotonMaster luminometer, following the manufacturer's instructions) marketed for use in the Oil&Gas industry. The calculations made with the device of the invention were performed based both on determining peak current and charge for the amperometric measurements.

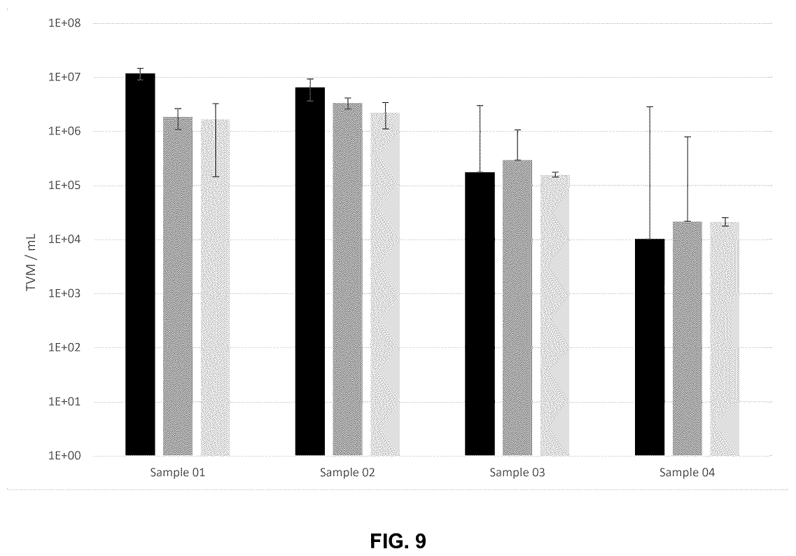

The correlation between the results obtained by the device of the invention and the commercial device was excellent (R²=0.99). Data dispersion was also similar for both methods, around 15/30% (FIG. 9).

What is claimed is:

1) An electrode cartridge comprising two subunits, wherein
the first subunit comprises
a main compartment with three openings, wherein the first and second opening are located in opposite ends of the compartment on a longitudinal axis, and the third opening is located perpendicular to the other two openings, a working electrode (WE), and a counter electrode (CE), wherein said working electrode and counter electrode are located within said main compartment;
the second subunit comprising a detachable adapter that can be attached to and detached from the main compartment from the third opening, and a reference electrode (RE) located within said detachable adapter.

2) The electrode cartridge according to claim 1, wherein the main compartment openings comprise leak-proof connectors.

3) The electrode cartridge according to claim 2, wherein the leak-proof connectors are selected from Luer connectors, barb connectors, and thread connectors.

4) The electrode cartridge according to claim 1, wherein the electrode cartridge is utilized in a fluidic system, wherein a liquid sample flows through said electrode cartridge.

5) A device for the semiautomatic determination of the total viable microorganisms present in a liquid sample that comprises:
a fluidic system, wherein said fluidic system comprises
a sample solution container,
a measuring solution container,
at least one peristaltic pump connected to the sample solution container and the measuring solution container,
a pressure sensor downstream the at least one peristaltic pump,
a filtering cartridge downstream the pressure sensor,
an electrode cartridge according to claim 1 downstream from the filtering cartridge,
a flow sensor downstream the electrode cartridge,
a residue compartment downstream the flow sensor;
a thermostatic chamber, wherein said thermostatic chamber contains within
the filtering cartridge of the fluidic system fixed over the cartridge elevator system,
the electrode cartridge of the fluidic system fixed over the cartridge elevator system;
an electronic control module;
a data processing module;
an electrochemical control module, wherein said electrochemical control module comprises a potentiostat.

6) The device of claim 5, wherein the electronic control module comprises a computer that is connected to the electrochemical control module, the thermostatic chamber, the data processing module, the at least one peristaltic pump, the pressure sensor, the flow sensor, the bubble trap and the vibrating bubble eliminator.

7) The device of claim 6, wherein the computer controls the electrochemical control module and the data processing module thus providing the potentiostat with information to carry out an electrochemical reaction in the electrode cartridge, and collect current information from the electrodes comprised therein.

8) The device of claim 5, further comprising a cartridge elevator system.

9) The device of claim 6, further comprising a cartridge elevator system, which is also connected to the computer.

10) A method for determining the total viable microorganism (TVM) present in a liquid sample, comprising the steps of
a) obtaining a liquid sample containing microorganisms in suspension,
b) filtering the microorganisms present in the sample of step a)
c) cultivating the microorganisms obtained in step b) with a solution comprising redox mediators,
d) carrying out a reduction of the mediators with the microorganisms obtained in step b),
e) introducing the product of the reaction of step d) in an electrode cartridge according to claim 1.
f) oxidizing the product of the reaction of step d) with the electrode cartridge,
g) producing an amperometric signal via the oxidation reaction of step f),
h) calculating the TVM present in the liquid sample of step a) from the amperometric signal of step g).

11) The method of claim 10, wherein the redox mediators comprise a ferricyanide salt.

12) The method of claim 10, wherein the microorganisms contained in the liquid sample are capable of producing microbially induced corrosion (MIC).

13) The method of claim 10, wherein the microorganisms contained in the liquid sample are selected from the genera Gallionella, Crenothrix, Sphaerotilus, Siderocapsa, Thiobacillus, Pseudomonas, Desulfovibrio, Desulfomonas, or Desulfotomaculum.
